(19) United States
(12) Patent Application Publication
(10) Pub. No.: US 2014/0325436 A1
(43) Pub. Date: Oct. 30, 2014

(54) MOBILE COMMUNICATION TERMINAL FOR DISPLAYING EVENT-HANDLING VIEW ON SPLIT SCREEN AND METHOD FOR CONTROLLING THE SAME

(71) Applicant: Samsung Electronics Co., Ltd., Gyeonggi-do (KR)

(72) Inventors: Chul-Joo Kim, Gyeonggi-do (KR); Kang-Tae Kim, Gyeonggi-do (KR); Duck-Hyun Kim, Gyeonggi-do (KR); Eun-Young Kim, Gyeonggi-do (KR); Kwang-Won Sun, Gyeonggi-do (KR)

(73) Assignee: Samsung Electronics Co., Ltd., Gyeonggi-do (KR)

(21) Appl. No.: 14/359,007

(22) PCT Filed: Nov. 16, 2012
(86) PCT No.: PCT/KR2012/009762

§ 371 Date: May 16, 2014

(30) Foreign Application Priority Data
Nov. 16, 2011 (KR) 10-2011-0119880

(51) Int. Cl. G06F 3/0482; G06F 3/0488; G06F 3/0484

(52) U.S. Cl. CPC G06F 3/0482; G06F 3/0484; G06F 3/0488
USPC 715/790

(57) ABSTRACT

Provided is a mobile communication terminal for displaying an event-handling view. The mobile communication terminal includes a touch screen, and a controller configured to generate, if an event requiring display on the touch screen occurs while a first window in which a first application is executed is displayed on the touch screen, an event-handling view corresponding to the event in a second window, and display the second window overlapped on the first window.

### PRIORITY

This application is a National Phase Entry of PCT International Application No. PCT/KR2012/009762, which was filed on Nov. 16, 2012, and claims priority to Korean Patent Application No. 10-2011-0119880, which was filed on Nov. 16, 2011, the content of each of which is incorporated herein by reference.

### BACKGROUND OF THE INVENTION

1. Field of the Invention

The present invention relates generally to a mobile communication terminal for displaying a split screen, and more particularly, to a mobile communication terminal for displaying an event-handling view on a split screen and a method for controlling the same.

2. Description of the Related Art

With the recent increasing demand for smart phones and tablet computers, many studies have been conducted on user interface methods associated with a touch screen mounted on the smart phones and tablet computers. In particular, studies have been conducted to allow the smart phones and tablet computers to provide interface methods closely related to the intuition associated with the user experience. Accordingly, a variety of interface methods conforming to a user's intuition have been released.

Conventional smart phones or tablet computers are not adapted to display events differently depending on their features. A handling view for each event is determined depending on the specification defined by application development vendors. For example, when a call is received, a full-screen call view may be displayed, and when a message is received, a smart phone or a tablet computer may show a user a notification momentarily, and then display a message view in a full screen depending on the user's choice. In both cases, the event-handling view is displayed in the full screen, and the user may have difficulty determining how to handle each event.

As described above, with conventional smart phones or tablet computers, the user may not be able to watch the ongoing main view while checking or reading an event-handling view. In order for the smart phone or tablet computer to display the ongoing event-handling view, the user must use a task manager or terminate the ongoing top-level event-handling view, which complicates user manipulation.

Since the user cannot determine the event view handling method depending on the features of each event, the conventional smart phones or tablet computers may display a relevant event-handling view on the full screen regardless of the user's intent. In this case, if the user needs to continuously perform the ongoing operation, such as when the user is running a navigation application while driving, the user may experience an unintended interruption, which is a further problem of the conventional art.

### SUMMARY OF THE INVENTION

An aspect of the present invention is to address at least the above-mentioned problems and/or disadvantages and to provide at least the advantages described below. Accordingly, an aspect of an embodiment of the present invention is to provide a mobile communication terminal for independently displaying event-handling views in a specified position in the minimum size upon receiving multiple events in a single-view device, thereby ensuring the user's simple manipulation and preventing the user from undergoing interference, and a method for controlling the same.

Another aspect of an embodiment of the present invention is to provide a mobile communication terminal for allowing a user to change and apply a procedure for independently handling an event-handling view for each received event depending on the features of the received event, and a method for controlling the same.

In accordance with an aspect of the present invention, there is provided a mobile communication terminal comprising a touch screen, and a controller configured to generate, if an event requiring display on the touch screen occurs while a first window in which a first application is executed is displayed on the touch screen, an event-handling view corresponding to the event in a second window, and display the second window overlapped on the first window.

In accordance with another aspect of the present invention, there is provided a method for controlling a mobile communication terminal with a touch screen displaying a first window for execution of a first application and a second window for execution of a second application. The method includes displaying the first window in which the first application is executed, on the touch screen, determining whether an event requiring display on the touch screen has occurred, generating, if the event has occurred, an event-handling view corresponding to the event, and generating the event-handling view in the second window and displaying the second window overlapped on the first window.

### BRIEF DESCRIPTION OF THE DRAWINGS

The above and other aspects, features, and advantages of the present invention will be more apparent from the following detailed description taken in conjunction with the accompanying drawings, in which:

FIG. 1a is a block diagram of a mobile communication terminal with a touch screen according to an embodiment of the present invention;

FIG. 1b is a schematic block diagram of a mobile communication terminal according to another embodiment of the present invention;

FIG. 2a is a perspective view of a mobile communication terminal according to an embodiment of the present invention;

FIGS. 2b and 2c illustrate a mobile communication terminal with a touch screen displaying first and second windows according to an embodiment of the present invention;

FIG. 2d illustrates a mobile communication terminal with a touch screen displaying first, second and third windows according to an embodiment of the present invention;

FIG. 3 illustrates an event handling process in a mobile communication terminal according to an embodiment of the present invention;

FIGS. 4a to 4c illustrate a description of an event handling process in a mobile communication terminal according to an embodiment of the present invention;

FIG. 4d illustrates a description of termination of a second application according to another embodiment of the present invention;

FIG. 5 illustrates a description of an event handling process according to another embodiment of the present invention;

FIG. 6 illustrates an event handling process in a mobile communication terminal according to an embodiment of the present invention; and

FIG. 7 illustrates a mobile communication terminal in which a main view is displayed in a first window of a touch screen and multiple event-handling views are displayed in a second window of the touch screen in an overlapping manner.

### DETAILED DESCRIPTION OF EMBODIMENTS OF THE INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

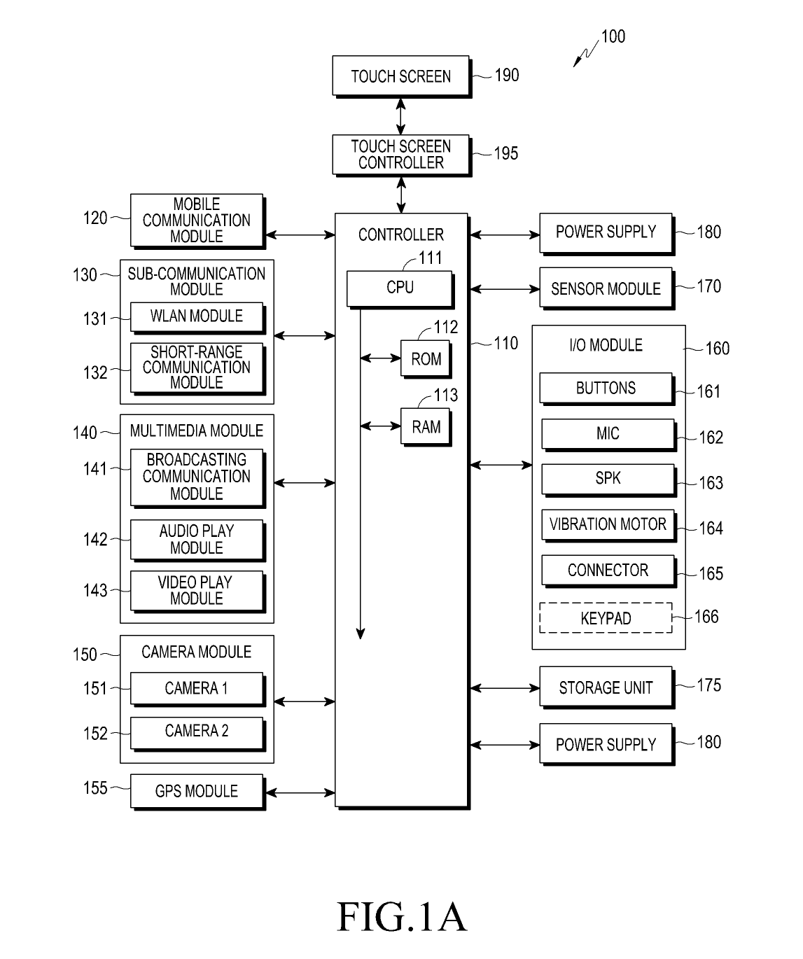

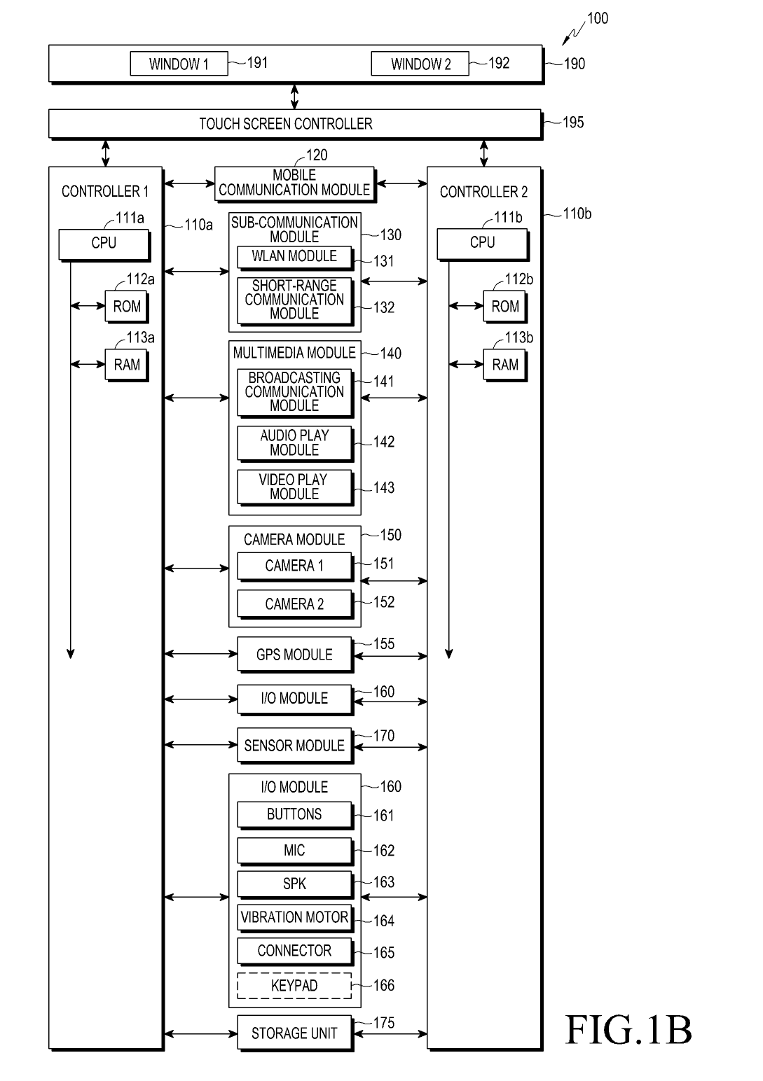

FIG. 1a is a block diagram of a mobile communication terminal with a touch screen according to an embodiment of the present invention.

As shown in FIG. 1a, a mobile communication terminal 100 with a touch screen may be connected to an external device (not shown) using a mobile communication module 120, a sub-communication module 130, and a connector 165. The external device may include another device such as a mobile phone (not shown), a smart phone (not shown), a tablet Personal Computer (PC) (not shown), and a server (not shown).

Referring to FIG. 1a, the mobile communication terminal 100 includes a touch screen 190 and a touch screen controller 195, a controller 110, the mobile communication module 120, the sub-communication module 130, a multimedia module 140, a camera module 150, a Global Positioning System (GPS) module 155, an Input/Output (I/O) module 160, a sensor module 170, a storage unit 175, and a power supply 180. The sub-communication module 130 includes at least one of a Wireless Local Area Network (WLAN) module 131 and a short-range communication module 132, and the multimedia module 140 includes at least one of a broadcast communication module 141, an audio play module 142, and a video play module 143. The camera module 150 includes at least one of a first camera 151 and a second camera 152, and the I/O module 160 includes at least one of buttons 161, a microphone (MIC) 162, a speaker (SPK) 163, a vibration motor 164, the connector 165, and a keypad 166.

The controller 110 includes a Central Processing Unit (CPU) 111, a Read Only Memory (ROM) 112 for storing a control program for controlling the mobile communication terminal 100, and a Random Access Memory (RAM) 113 used as a storage area for storing signals or data received externally to the mobile communication terminal 100 or for performing an operation executed in the mobile communication terminal 100. The CPU 111 may include a single core, dual cores, triple cores, or quad codes. The CPU 111, the ROM 112 and the RAM 113 may be connected to one another through an internal bus.

The controller 110 controls the mobile communication module 120, the sub-communication module 130, the multimedia module 140, the camera module 150, the GPS module 155, the I/O module 160, the sensor module 170, the storage unit 175, the power supply 180, the touch screen 190, and the touch screen controller 195.

The mobile communication module 120 connects the mobile communication terminal 100 to the external device by mobile communication using one or multiple antennas (not shown) under control of the controller 110. The mobile communication module 120 transmits/receives wireless signals for a voice call, a video call, a Short Message Service (SMS) message or a Multimedia Message Service (MMS) message, to/from a mobile phone (not shown), a smart phone (not shown), a tablet PC (not shown) or another device (not shown), which has the phone number entered to the mobile communication terminal 100.

The sub-communication module 130 includes at least one of the WLAN module 131 and the short-range communication module 132.

The WLAN module 131 may be connected to the Internet in a place area where a wireless Access Point (AP) (not shown) is installed, under control of the controller 110. The WLAN module 131 supports the WLAN standard IEEE802.11x of the Institute of Electrical and Electronics Engineers (IEEE). The short-range communication module 132 may perform wireless short-range communication between the mobile communication terminal 100 and an image-forming device (not shown) under control of the controller 110. The short-range communication scheme includes, for example, Bluetooth® and Infrared Data Association (IrDA).

The mobile communication terminal 100 includes at least one of the mobile communication module 120, the WLAN module 131, and the short-range communication module 132 depending on terminal performance.

The multimedia module 140 includes the broadcast communication module 141, the audio play module 142, and the video play module 143. The broadcast communication module 141 receives broadcast signals (e.g., TV broadcast signals, radio broadcast signals, or data broadcast signals) and additional broadcast information (e.g., Electric Program Guide (EPG) or Electric Service Guide (ESG)), which are transmitted from the broadcasting station via a broadcast communication antenna (not shown), under control of the controller 110. The audio play module 142 plays the stored or received digital audio files (e.g., files with a file extension of mp3, wma, ogg or way) under control of the controller 110. The video play module 143 plays the stored or received digital video files (e.g., files with a file extension of mpeg, mpg, mp4, avi, mov, or mkv) under control of the controller 110. The video play module 143 may also play digital audio file.

Alternatively, the multimedia module 140 does not include the broadcast communication module 141, and the audio play module 142 or the video play module 143 in the multimedia module 140 may be incorporated into the controller 110.

The camera module 150 includes at least one of the first and second cameras 151 and 152 that capture still images or videos under control of the controller 110. The first camera 151 or the second camera 152 includes a secondary light source (e.g., a flash (not shown)) that provides the light necessary for image capturing. Alternatively, the first camera 151 and the second camera 152 may be mounted close to each other (for example, the gap between the first and second cameras 151 and 152 is between 1 cm and 8 cm), enabling capture of three-dimensional (3D) still images or 3D videos. If the gap between the first camera 151 and the second camera 152 is less than the horizontal length (e.g., which is perpendicular to a gap D1) of a first housing 100a, the first and second cameras 151 and 152 may be mounted on the front or rear of the mobile communication terminal 100.

The GPS module 155 receives radio waves from multiple GPS satellites (not shown) in Earth's orbit, and calculates the location of the mobile communication terminal 100 based on the Time of Arrival (ToA) from the GPS satellites to the mobile communication terminal 100.

The I/O module 160 includes at least one of the multiple buttons 161, the microphone 162, the speaker 163, the vibration motor 164, the connector 165, and the keypad 166.

The microphone 162 receives sounds and generates electrical signals under control of the controller 110. One or multiple microphones 162 may be mounted in the mobile communication terminal 100.

The speaker 163 outputs the sounds corresponding to various signals (e.g., wireless signals, broadcast signals, digital audio files, digital video files or photo shoot signals) from the mobile communication module 120, the sub-communication module 130, the multimedia module 140 or the camera module 150, to the outside of the mobile communication terminal 100 under control of the controller 110. The speaker 163 outputs the sounds (e.g., a button manipulation tone or a ring-back tone for a phone call) corresponding to the functions performed by the mobile communication terminal 100.

In accordance with an embodiment of the present invention, the speaker 163 outputs the sounds corresponding to the continuous movement of one touch from a first touch screen 190a to a second touch screen 190b.

The vibration motor 164 converts electrical signals into mechanical vibrations under control of the controller 110. For example, the mobile communication terminal 100 in a vibration mode operates the vibration motor 164 upon receiving a voice call from another device (not shown).

The vibration motor 164 of the mobile communication terminal 100 may operate in response to a touch on the touch screen 190.

The connector 165 is used as an interface for connecting the mobile communication terminal 100 to the external device (not shown) or the power source (not shown). The connector 165 transmits the data stored in the storage unit 175 of the mobile communication terminal 100 to the external device (not shown) or receive data from the external device (not shown) through a wired cable connected to the connector 165 under control of the controller 110. Power from the power source (not shown) is input to the mobile communication terminal 100 or charges the battery (not shown) through the wired cable connected to the connector 165.

The keypad 166 receives key inputs from the user for control of the mobile communication terminal 100. The keypad 166 includes a physical keypad (not shown) formed on the mobile communication terminal 100, or virtual keypad (not shown) displayed on the touch screen 190. The physical keypad (not shown) formed on the mobile communication terminal 100 may be excluded depending on the performance or structure of the mobile communication terminal 100.

The sensor module 170 includes at least one sensor for detecting the status of the mobile communication terminal 100. For example, the sensor module 170 includes a proximity sensor (not shown) for detecting the user's approach to the mobile communication terminal 100, an illuminance sensor (not shown) for detecting the amount of ambient light around the mobile communication terminal 100, or a motion sensor (not shown) for detecting the motion of the mobile communication terminal 100 (e.g., the rotation of the mobile communication terminal 100, and the acceleration or vibration applied to the mobile communication terminal 100). At least one of the sensors detects the status, generate a signal corresponding to the detection, and transfer the result to the controller 110. Sensors for the sensor module 170 may be added or deleted depending on the performance of the mobile communication terminal 100.

Under control of the controller 110, the storage unit 175 stores the signals or data which are input/output to correspond to an operation of the mobile communication module 120, the sub-communication module 130, the multimedia module 140, the camera module 150, the GPS module 155, the I/O module 160, the sensor module 170, the first touch screen 190a or the second touch screen 190b. The storage unit 175 stores a control program for control of the mobile communication terminal 100 or the controller 110.

The term ‘storage unit’ includes, for example, the storage unit 175, the ROM 112 and the RAM 113 in the controller 110, or a memory card (not shown, such as a Secure Digital (SD) card and a memory stick) mounted in the mobile communication terminal 100. The storage unit includes a non-volatile memory, a volatile memory, a Hard Disk Drive (HDD), or a Solid State Drive (SSD).

The power supply 180 supplies power to one or multiple batteries (not shown) under control of the controller 110. The one or multiple batteries (not shown) supply power to the mobile communication terminal 100. The power supply 180 supplies the power received from the external power source (not shown) to the mobile communication terminal 100 through a wired cable connected to the connector 165.

The touch screen 190 provides a User Interface (UI) corresponding to each of various services (e.g., call, data transmission, broadcasting, and photo shooting) to the user. The touch screen 190 transfers an analog signal corresponding to at least one touch input to the user interface to the touch screen controller 195. The touch screen 190 receives or detects at least one touch through the user's body (e.g., fingers including the thumb) or a touching device (e.g., a stylus pen). The touch screen 190 detects a continuous movement of one touch during at least one touch action. The touch screen 190 transfers an analog signal corresponding to the detected continuous movement of the touch to the touch screen controller 195.

In the present invention, the touch is not limited to the contact between the touch screen 190 and the user's body or the touching device, but may include a non-contact touch (for example, a detectable gap between the touch screen 190 and the user's body or the touching device is less than or equal to 1 mm). The gap detectable by the touch screen 190 is subject to change depending on the performance or structure of the mobile communication terminal 100.

The touch screen 190 may be implemented in, for example, resistive, capacitive, infrared, or acoustic wave type.

The touch screen controller 195 converts the analog signals received from the touch screen 190 into digital signals (e.g., X and Y coordinates), which it transfers to the controller 110 for use in controlling the touch screen 190. For example, the controller 110 may select or run a shortcut icon (not shown) displayed on the touch screen 190 in response to the touch. The touch screen controller 195 may be incorporated into the controller 110.

FIG. 1b is a schematic block diagram of a mobile communication terminal according to another embodiment of the present invention.

Referring to FIG. 1b, among components of the mobile communication terminal 100, the remaining components except for a first controller 110a, a second controller 110b and a touch screen 190 are substantially the same as those in FIG. 1a. Thus, a detailed description thereof will be omitted.

The first controller 110a includes a CPU 111a, a ROM 112a for storing a control program for control of the mobile communication terminal 100, and a RAM 113a used as a storage area for storing signals or data received externally to the mobile communication terminal 100 or for performing an operation executed in the mobile communication terminal 100.

The first controller 110a controls the mobile communication module 120, the sub-communication module 130, the multimedia module 140, the camera module 150, the GPS module 155, the I/O module 160, the sensor module 170, the storage unit 175, the power supply 180, a first window 191 of the touch screen 190, and the touch screen controller 195. The first window 191 and a second window 192 indicate independent areas that are obtained by splitting the touch screen 190. The first and second windows 191 and 192 may be implemented by simply splitting the entire touch screen 190, may correspond to independent areas belonging to the entire touch screen 190, may be independent split areas of the touch screen 190 from the visual perspective of the user, or may be independent spilt sets of pixels included in the touch screen 190 in terms of hardware. The conceptual location relationship between the first and second windows 191 and 192 will be described in detail below.

The touch screen controller 195 converts analog signals received from the touch screen 190, particularly from a touch screen portion corresponding to the first window 191, into digital signals (e.g., X and Y coordinates), and transfers the digital signals to the first controller 110a. The first controller 110a controls the first window 191 of the touch screen 190 using the digital signals received from the touch screen controller 195. The touch screen controller 195 may be incorporated into the first controller 110a.

The second controller 110b includes a CPU 111b, a ROM 112b for storing a control program for control of the mobile communication terminal 100, and a RAM 113b used as a storage area for storing signals or data received externally to the mobile communication terminal 100 or for performing an operation executed in the mobile communication terminal 100.

The second controller 110b controls the mobile communication module 120, the sub-communication module 130, the multimedia module 140, the camera module 150, the GPS module 155, the I/O module 160, the sensor module 170, the storage unit 175, the power supply 180, the touch screen 190 (particularly the second window 192 of the touch screen 190), and the touch screen controller 195.

The touch screen controller 195 converts analog signals received from the touch screen 190 corresponding to the second window 192, into digital signals (e.g., X and Y coordinates), and transfers the digital signals to the second controller 110b. The second controller 110b controls the touch screen 190, particularly the touch screen corresponding to the second window 192 using the digital signals received from the touch screen controller 195. The touch screen controller 195 may be incorporated into the second controller 110b.

In an embodiment of the present invention, the first controller 110a controls at least one component (e.g., at least one of the touch screen 190, the touch screen controller 195, the mobile communication module 120, the sub-communication module 130, the multimedia module 140, the first camera 151, the GPS module 155, a first button group 161a, a power/lock button (not shown), at least one volume button (not shown), the sensor module 170, the storage unit 175, and the power supply 180).

The second controller 110b controls at least one component (e.g., at least one of the touch screen 190, the touch screen controller 195, the second camera 152, a second button group 161b, the storage unit 175 and the power supply 180).

In another embodiment of the present invention, the first and second controllers 110a and 110b control the components of the mobile communication terminal 100 on a module basis. For example, the first controller 110a controls the mobile communication module 120, the sub-communication module 130, and the I/O module 160, and the second controller 110b controls the multimedia module 140, the camera module 150, the GPS module 155, and the sensor module 170. The first and second controllers 110a and 110b may control the components of the mobile communication terminal 100 based on priority, such as the first controller 110a prioritizing the mobile communication module 120, and the second controller 110b prioritizing the multimedia module 140. The first and second controllers 110a and 110b may be separated from each other, and may be implemented in a single controller having a multi-core CPU such as a dual-core CPU.

More specifically, the first and second controllers 110a and 110b may independently perform rendering or interfacing operations on the first and second windows 191 and 192 of the touch screen 190, respectively.

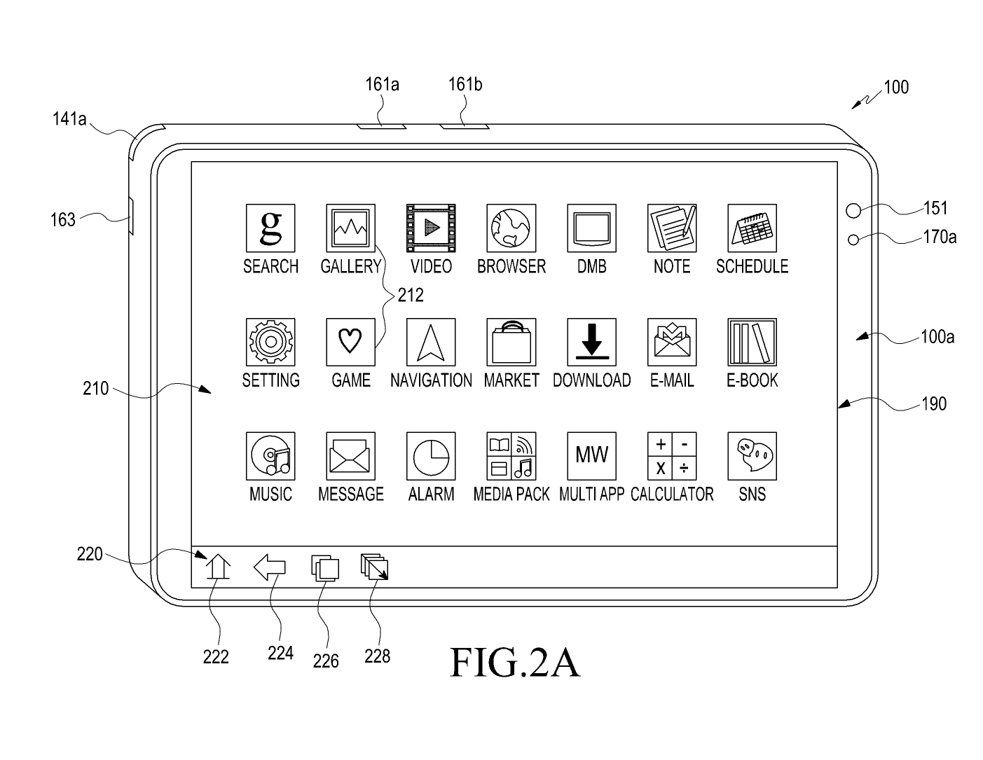

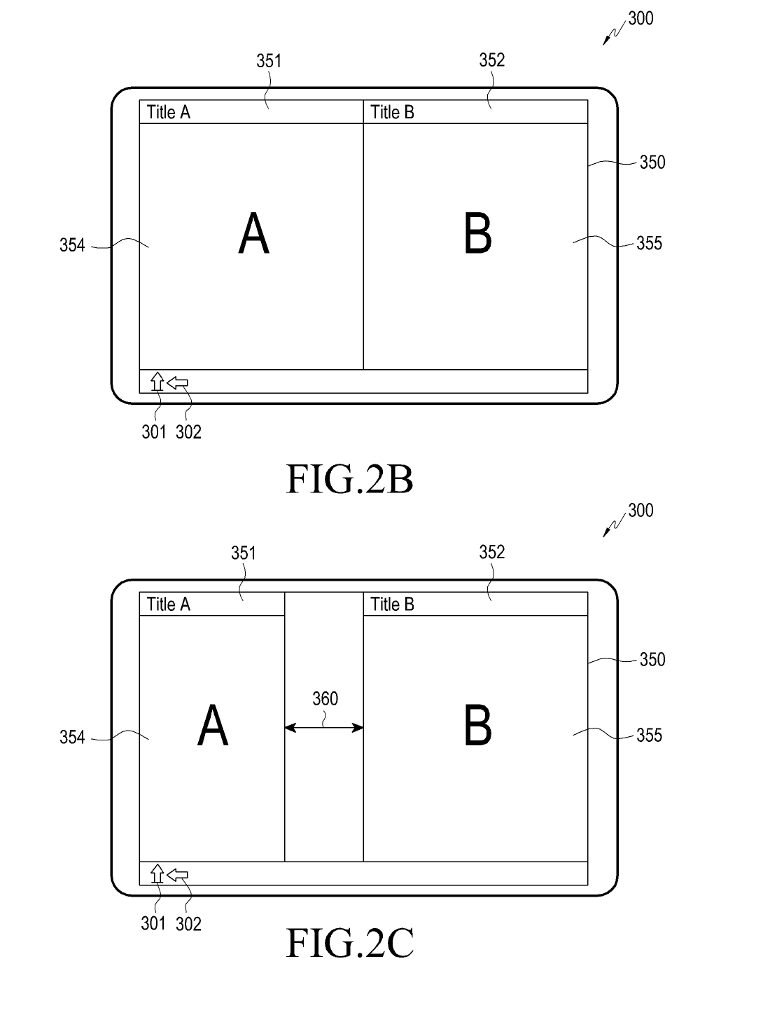

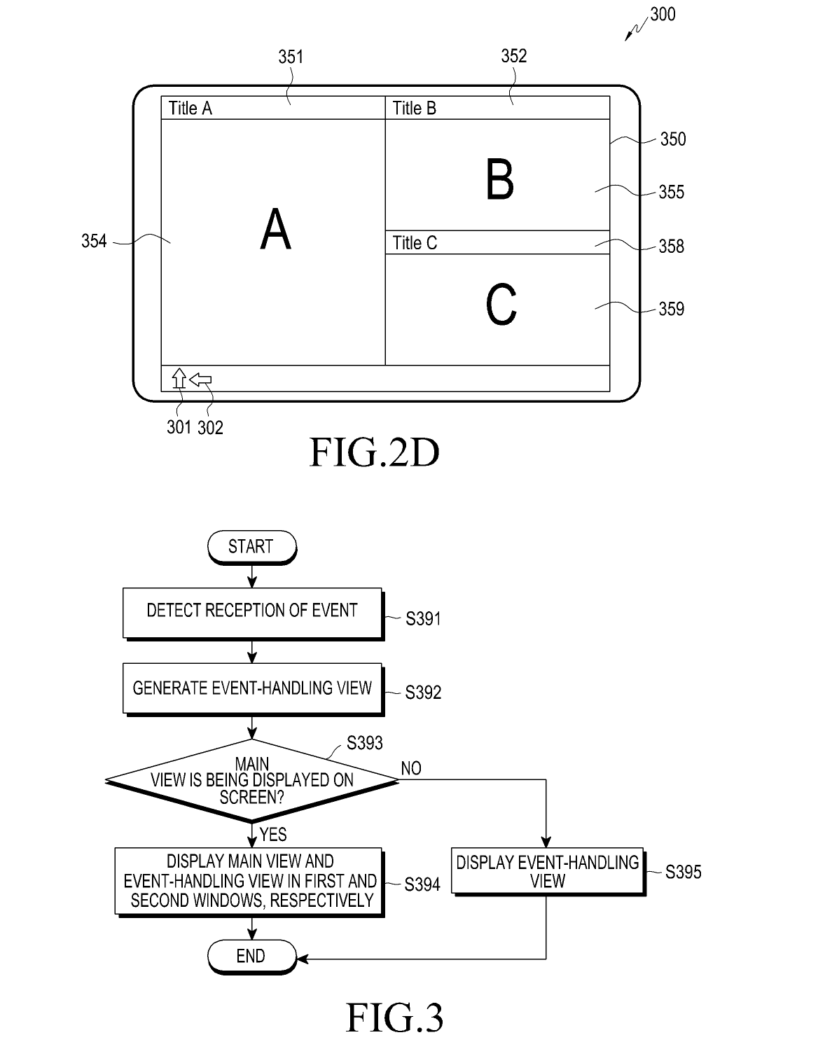

FIG. 2a is a perspective view of a mobile communication terminal according to an embodiment of the present invention.

Referring to FIG. 2a, the touch screen 190 is disposed at the center of a front 100a of the mobile communication terminal 100. The touch screen 190 is formed large enough to occupy most of the front 100a of the mobile communication terminal 100. The first camera 151 and an illuminance sensor 170a are disposed at an edge of the front 100a of the mobile communication terminal 100. For example, on a side 100b of the mobile communication terminal 100 are disposed a power/reset button 161a, a volume button 161b, the speaker 163, a terrestrial Digital Multimedia Broadcasting (DMB) antenna 141a for broadcast reception, a microphone (not shown), and a connector (not shown), and on the back (not shown) of the mobile communication terminal 100 is disposed a second camera (not shown).

The touch screen 190 includes a main screen 210 and a menu key collection stack 220. In FIG. 2a, horizontal lengths for the mobile communication terminal 100 and the touch screen 190 are set longer than the vertical lengths. In this case, the touch screen 190 is horizontally situated.

One or multiple applications are executed in the main screen 210. In the example of FIG. 2a, a home screen is displayed on the touch screen 190. The home screen is the first screen, which is displayed on the touch screen 190 when the mobile communication terminal 100 is powered up. On the home screen are arranged and displayed multiple application execution icons 212 in rows and columns, and applications corresponding to the icons 212 being stored in the mobile communication terminal 100. The application execution icons 212 may be formed as icons, buttons, or texts, for example. If each application execution icon 212 is touched, an application corresponding to the touched application execution icon 212 is executed and displayed on the main screen 210.

The menu key collection stack 220 is horizontally elongated at the bottom of the touch screen 190, and includes standard function buttons 222 to 228. A home screen button 222 is used to display the home screen on the main screen 210. For example, if the home screen button 222 is touched while applications are being executed on the main screen 210, the home screen will be displayed on the main screen 210. A back button 224 is used to display the screen that was displayed just before the current screen, or to terminate the ongoing application. A multi-view mode button 226 is used to display applications on the main screen 210 in a multi-view mode disclosed in the present invention. A mode switch button 228 is used to switch the ongoing multiple applications between different modes on the main screen 210. For example, if the mode switch button 228 is touched, switching may occur between an overlap mode and a split mode in the mobile communication terminal 100. In the overlap mode, multiple applications are displayed in a manner partially overlapping each other. In the split mode, the multiple applications are separately displayed in different areas on the main screen 210.

On the top of the touch screen 190 may be formed a top bar (not shown) for displaying the status of the mobile communication terminal 100, such as battery charging status, received signal strength, and current time.

Depending on the Operating System (OS) of the mobile communication terminal 100 or the application being executed in the mobile communication terminal 100, the menu key collection stack 220 and the top bar (not shown) may not be displayed on the touch screen 190. If both the menu key collection stack 220 and the top bar are not displayed on the touch screen 190, the main screen 210 may be displayed on the entire touch screen 190. The menu key collection stack 220 and the top bar may be displayed semi-transparently on the main screen 210 in an overlapping manner.

FIG. 2b illustrates a mobile communication terminal with a touch screen displaying first and second windows according to an embodiment of the present invention.

As shown in FIG. 2b, a mobile communication terminal 300 includes a touch screen 350 of the type previously described. In the example of FIG. 2b, the mobile communication terminal 300 may display first and second title bars 351 and 352, first and second application execution screens 354 and 355, and menu keys 301 and 302 on the touch screen 350.

The first and second title bars 351 and 352 may display texts, numbers or figures that can implicitly indicate identities of first and second applications, respectively. Although the first and second title bars 351 and 352 may be implemented to be elongated in the direction of, for example, the horizontal axis, it will be apparent to those of ordinary skill in the art that this implementation is merely illustrative, and the first and second title bars 351 and 352 may be replaced by any means that can indicate identities of applications.

The first and second application execution screens 354 and 355 may display their own independent application execution screens. The first and second application execution screens 354 and 355 are substantially rectangular in shape, and are disposed under the first and second title bars 351 and 352, respectively. The first and second application execution screens 354 and 355 display information such as texts and multimedia data, to correspond to the configurations of applications.

The first title bar 351 and the first application execution screen 354 may be referred to as a first window. The window displays both an application execution screen and an identity for one application, and includes at least one view. The view, one independent display unit, is an object that can provide a visual image, such as a text view that displays predetermined texts during coding as a view for displaying predetermined texts, and an image view for displaying resource, file and web images.

The mobile communication terminal 300 independently displays first and second applications in first and second windows, respectively. In other words, execution or termination of the first application does not interfere with execution or termination of the second application. Accordingly, even if the first application is terminated, the second application may be displayed in the second window 352 and 355. As another example, the second application may be displayed in both the first and second windows.

The menu keys 301 and 302 provide a function capable of manipulating the overall operation of the mobile communication terminal 300. For example, if the user touches the menu key 301, the mobile communication terminal 300 provides a menu screen. If the user touches the menu key 302, the mobile communication terminal 300 re-displays the screen that was displayed in the previous step. The manipulation by a touch on the menu keys 301 and 302 is just illustrative, and those of ordinary skill in the art may easily understand various other possible implementations for manipulating the overall operation of the mobile communication terminal 300 by one or more manipulations of the menu keys 301 and 302. In FIG. 2b, the menu keys 301 and 302 may be elongated in a direction parallel with a part of the touch screen 350, e.g., with the first and second application execution screens 354 and 355. Although the menu keys 301 and 302 are implemented to be displayed on the ouch screen 350 as described above, this is simply illustrative, and they may be implemented as physical buttons which are spaced apart from the touch screen 350.

Splitting the touch screen 350 into the first and second windows as shown in FIG. 2b is an example, and it will be understood by those of ordinary skill in the art that the first and second windows are not limited by size as long as they are displayed independently of each other. In other words, the first window may be displayed larger or smaller than the second window.

FIG. 2c illustrates a mobile communication terminal with a touch screen displaying first and second windows according to another embodiment of the present invention. Unlike in FIG. 2b, the first window 351 and 354 and the second window 352 and 355 in FIG. 2c are spaced part from each other by a gap. It will be understood by those of ordinary skill in the art that even in the example of FIG. 2c, the first and second windows are not limited by size as long as the windows are independently displayed.

FIG. 2d illustrates a mobile communication terminal with a touch screen displaying first, second and third windows according to an embodiment of the present invention.

As shown in FIG. 2d, three windows may be displayed on the touch screen 350. A first window 351 and 354, a second window 352 and 355, and a third window 358 and 359 may be displayed on the touch screen 350, and the first, second and third windows include first, second and third application display screens 354, 355 and 359 for displaying first, second and third applications, and first, second and third title bars 351, 352 and 358 for application identification, respectively.

FIG. 3 illustrates an event handling process in a mobile communication terminal according to an embodiment of the present invention.

In step S391, the controller 110 of the mobile communication terminal determines whether an event has been received. The event may refer to receiving a message requiring a notification such as an SMS message from a mobile communication module, requesting a call operation, and an alarm.

In step S392, the controller 110 determines the type of the received event and generates an event-handling view corresponding to the received event. The controller 110 determines the type of the received event based on an event-handling view algorithm or an event-handling view program, which is read from the storage unit 175. The event-handling view algorithm or program includes a configuration to identify the type of an event, a configuration associated with an operation required in event handling, and a configuration to render an event-handling view. In other words, the controller 110 determines the type of a received event, and based on the information included in a header of the received event, which is defined by a communication scheme, the controller 110 determines whether the received event occurred within the mobile communication terminal, such as an SMS message, a call operation request, and an alarm.

In addition, the controller 110 may handle an event by a handling operation process for a received event, such as by extracting character or numeric information included in an SMS message. The controller 110 may perform a process of rendering an event-handling view, such as rendering an event-handling view image based on the extracted character or numeric information, so as to allow the user to visually identify the event-handling view image.

In step S393, the controller 110 determines whether a main view (e.g., the ongoing view or window) is being displayed on the touch screen, such as by checking whether a program or application specified to be displayed on the touch screen is loaded on a ROM or a RAM.

In step S394, if it is determined that the main view is being displayed on the screen, the controller 110 independently displays the main view and the event-handling view in first and second windows on the touch screen, respectively. Display of the main view and the event-handling view is controlled by the controller 110, and specifically, by first and second controllers 110a and 110b, respectively. Display and operation of the event-handling view, unlike in the conventional scheme where the screen is manually switched, may be controlled by an independent controller 110, and the event-handling view may be actively displayed in the second window of the touch screen as a single application.

In step S395, if it is determined that the main view is not being displayed on the screen, the controller 110 may display the event-handling view on the entire touch screen 190.

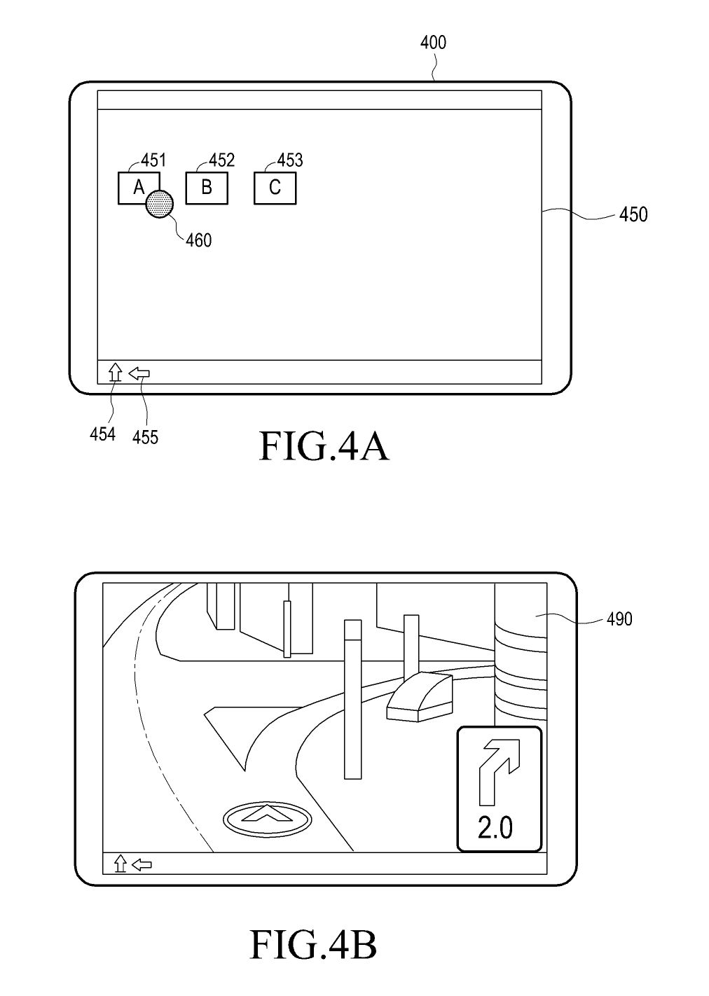

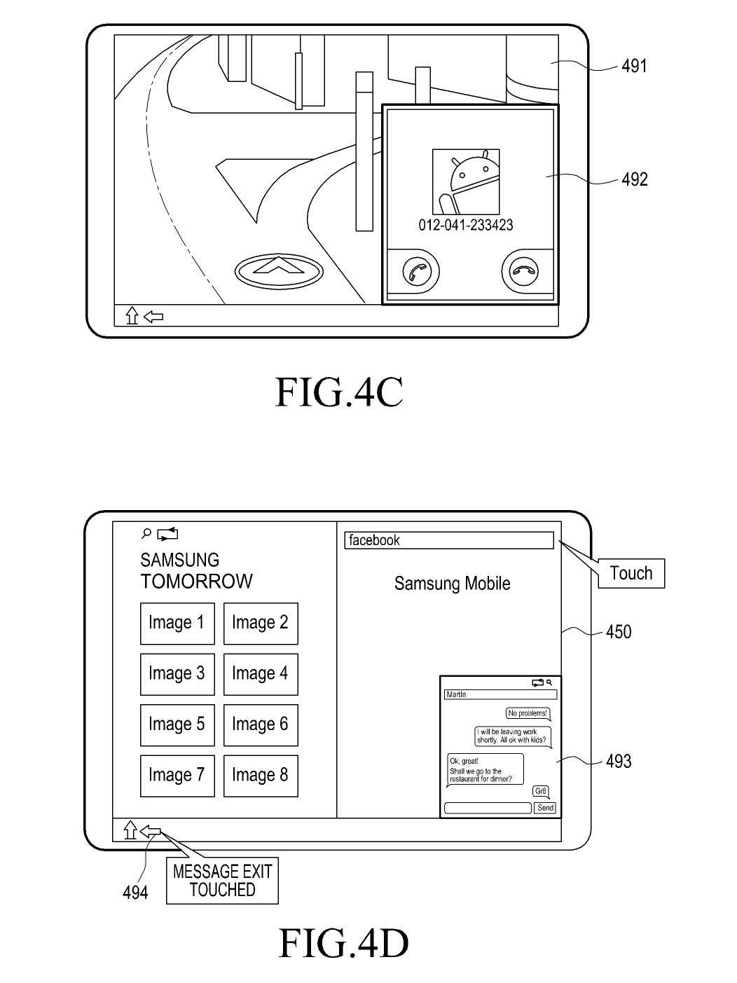

FIGS. 4a to 4c illustrate a description of an event handling process in a mobile communication terminal according to an embodiment of the present invention.

As shown in FIG. 4a, a mobile communication terminal 400 includes a touch screen 450, application execution icons 451, 452 and 453 displayed on the touch screen 450, and menu keys 454 and 455. A user may touch one 451 of the application execution icons 451, 452 and 453 (see 460) to run its associated application (e.g., an application A). The application A is assumed to be a navigation application.

FIG. 4b is the conceptual diagram in which a navigation application is displayed on the touch screen 450. As shown in FIG. 4b, the navigation application may be displayed on the entire touch screen 450 (see 490), or on a substantial portion of the touch screen 450 except for the menu key stack (see 490).

In this manner, the controller 110 determines the occurrence of an event, which is assumed to be a call operation request. Based on the call operation request, the controller 110 may render a call-receiving image corresponding thereto. More specifically, using phone number information included in the call operation request, the controller 110 may render a call-receiving image including the phone number information. If the user touches a specific part of the image, the controller 110 may load a call operation application capable of performing an incoming call operation.

As shown in FIG. 4c, the controller 110 displays a navigation application in a first window 491, and a call operation application in a second window 492. As shown, the second window 492 is displayed on the first window 491 in an overlapping manner. As described above, display operations for the first and second windows 491 and 492 are controlled by the controller 110, or by the first and second controllers 110a and 110b, respectively. Under this configuration, the user may run the call operation application in the second window without interference to an operation of the navigation application in the first window, thus maximizing user convenience.

The position or size of the second window 492 is adjustable by the user. The mobile communication terminal 400 provides a layout where the position or size of the second window 492 is adjustable. Accordingly, the user may edit the second window 492 to a desired position or in a desired size. In the example of FIG. 4c, the second window 492 is displayed in a smaller size than the first window 491.

FIG. 4d illustrates a description of termination of a second application according to another embodiment of the present invention. As shown in FIG. 4d, a second application (e.g., an SMS-receiving message) is in a second window 493 of the touch screen 450. The user may exclude the SMS-receiving message image displayed in the second window 493 from the displayed images by touching a menu key 494 (e.g., an exit menu key).

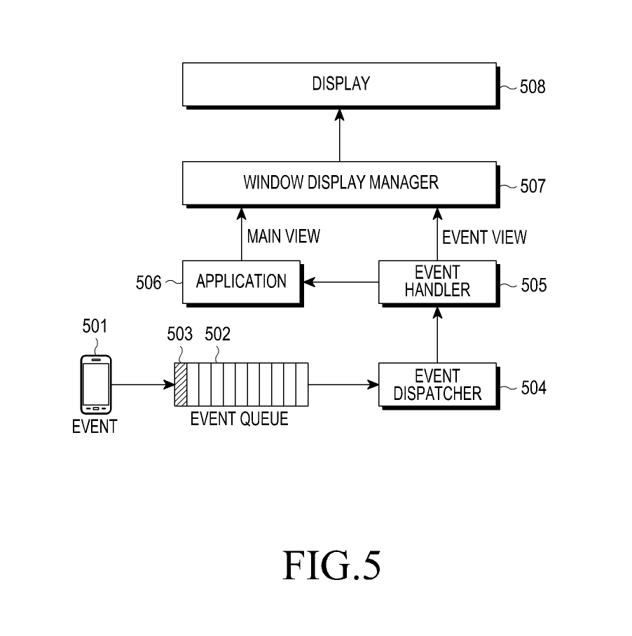

FIG. 5 illustrates a description of an event handling process according to another embodiment of the present invention.

As described above, the controller 110 detects the occurrence of an event 501. The event 501 is handled with one queue, and multiple queues may be stacked (see 502) in the order of occurrence. For example, assume that an SMS message is received first, an alarm event occurs second, and a call operation request event occurs third. In this case, an SMS message reception event is stacked in a first queue 503, an alarm event in a second queue, and a call operation request event in a third queue. The queues may be processed in the order of first, second and third queues on a First-In-First-Out (FIFO) basis.

An event dispatcher 504 monitors the event queues periodically or aperiodically, and sequentially transfers the events to an event handler 505 on a FIFO basis when the queue processing is required.

The event handler 505 handles the event(s) that the system has received from the event dispatcher 504, based on a predetermined scheme. The event handler 505 reads an event-handling view algorithm or program from a storage unit. The event-handling view algorithm or program, as described above, includes a configuration to identify the type of an event, a configuration associated with an operation required in event handling, and a configuration to render an event-handling view. In other words, the event handler 505 first determines the type of a received event, and based on the information included in a header of the received event, which is defined by a predetermined communication scheme, the event handler 505 determines whether the received event has occurred within the mobile communication terminal, such as an SMS message, a call operation request, and an alarm.

In addition, the event handler 505 may handle an event by a handling operation process for a received event, for example, by a process of extracting character or numeric information included in an SMS message. The event handler 505 may perform a process of rendering an event-handling view, for example, a process of rendering an event-handling view image based on the extracted character or numeric information so as to allow the user to visually identify the event-handling view image.

The event handler 505 may notify the occurrence of an event to the application that is presently being executed, i.e., which is being displayed on the touch screen. Accordingly, it is possible to determine whether to change display of the application presently being executed. A configuration for determining whether display of the application needs to be changed may be achieved by a window display manager 507.

The event handler 505 renders an event-handling view and outputs the view to the window display manager 507.

The window display manager 507 renders images so as to display the ongoing application in the first window of the touch screen and the event-handling view in the second window. The window display manager 507 re-sizes the execution screen for the ongoing application, or directly receives execution screen re-sizing information from the application and re-size the execution screen based thereon.

The window display manager 507 outputs the rendered image to the touch screen 508, which displays the ongoing application in the first window and the event-handling view in the second window.

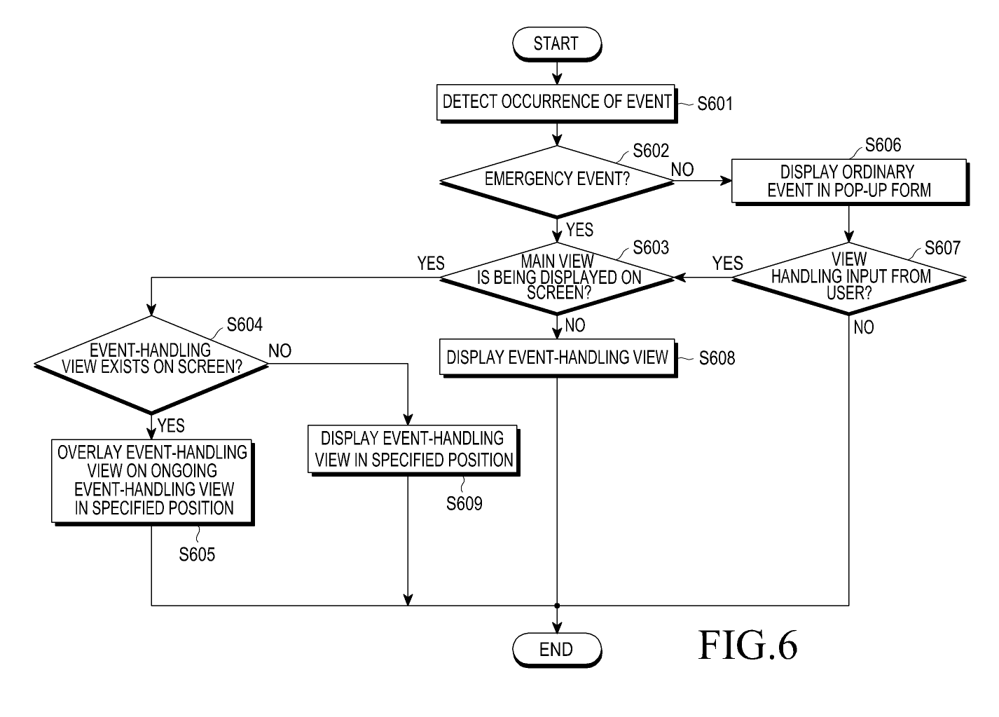

FIG. 6 illustrates an event handling process in a mobile communication terminal according to an embodiment of the present invention.

The controller 110 detects the occurrence of an event in step S601. A configuration, by which the controller 110 detects the occurrence of an event, has been described in detail, so a description thereof will be omitted.

Events may be classified into an emergency event and an ordinary event. The emergency event may be defined as, for example, a call and an alarm, and the ordinary event may be defined as, for example, the remaining events such as a message. This event classification is changeable by user settings, and it is apparent to those of ordinary skill in the art that the type or handling method of each event may be changed depending on the circumstances during execution of the relevant application.

For example, if a call is received while the user is using a navigation application or if an alarm occurs while the user is using a web browser, the detected event may be handled as an emergency event, and during reception of the event, a relevant event-handling view may be directly provided to the screen as a small window. If a message is received while the user is using a web browser, the detected event may be handled as an ordinary event, and during reception of the event, the controller 110 notifies a relevant event-handling view in the pop-up form, and provides the event-handling view by receiving a user's choice.

The controller 110 determines in step S602 whether the detected event is an emergency event or an ordinary event. The controller 110 determines the type of an event based on the previously stored look-up table associated with classification of emergency events and ordinary events. If it is determined that the detected event is an emergency event (Yes in step S602), the controller 110 determines in step S603 whether a main view is presently being displayed on the touch screen, such as by checking the presence/absence of an application loaded on a RAM or a ROM.

If it is determined that the detected event is an ordinary event (No in step S602), the controller 110 displays the ordinary event in the pop-up form in step S606. In step S607, the controller 110 receives an event handling command (e.g., an input to determine whether to display an ordinary event in an event-handling view) from the user. Upon receiving the input (Yes in step S607), the controller 110 determines in step S603 whether a main view is presently being displayed on the touch screen.

If the main view is not being displayed on the touch screen 190 (No in step S603), the controller 110 displays the event-handling view in a full screen in step S608.

If the main view is being displayed on the touch screen 190 (Yes in step S603), the controller 110 determines in step S604 whether another event-handling view exists on the screen. If there is no other event-handling view on the screen (No in step S604), the controller 110 displays the event-handling view in a specified position in step S609. In other words, the controller 110 displays the main view in the first window 191 of the touch screen 190, and the event-handling view in the second window 192.

If another event-handling view exists on the screen (Yes in step S604), the controller 110 displays the event-handling view on the ongoing event-handing view in a specified position in an overlapping manner in step S605. In other words, the controller 110 displays the main view in the first window 191 of the touch screen 190, and multiple event-handling views in the second window 192 of the touch screen 190 in an overlapping manner.

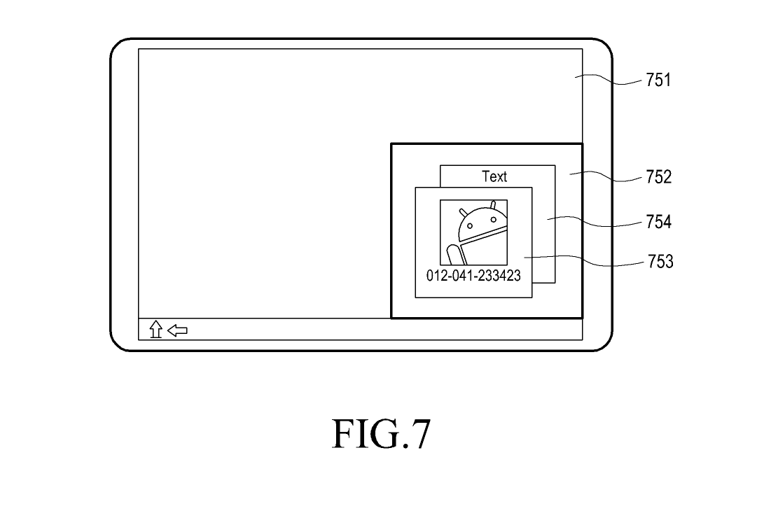

FIG. 7 illustrates a mobile communication terminal in which a main view is displayed in a first window of a touch screen and multiple event-handling views are displayed in a second window of the touch screen in an overlapping manner. As shown in FIG. 7, a main view (e.g., an ongoing application) is displayed in a first window 751 of a touch screen 750, and multiple event-handling views 753 and 754 are displayed in a second window 752.

In accordance with an embodiment of the present invention, multiple event-handling views 753 and 754 are disposed in the order of occurrence. For example, if the event-handling view 753 has occurred later than the event-handling view 754, the last occurred event-handling view 753 is disposed above the other views, such that the entirety of the event-handling view 753 is shown.

In accordance with another embodiment of the present invention, multiple event-handling views 753 and 754 are disposed in the order of predetermined settings. For example, if the user sets a higher priority for the event-handling view 753 compared to the event-handling view 754, the event-handing view 753 with the higher priority is displayed above the other views.

Displaying the multiple event-handling views 753 and 754 in an overlapping manner is a mere example, and the event-handling views 753 and 754 could also be spaced apart from each other.

While the invention has been shown and described with reference to certain embodiments thereof, it will be understood by those skilled in the art that various changes in form and details may be made therein without departing from the spirit and scope of the invention as defined by the appended claims and their equivalents.

1. A mobile communication terminal comprising:
a touch screen; and
a controller configured to generate, if an event requiring display on the touch screen occurs while a first window in which a first application is executed is displayed on the touch screen, an event-handling view corresponding to the event in a second window, and display the second window overlapped on the first window.

2. The mobile communication terminal of claim 1, wherein the controller is further configured to determine whether the first application is being executed on the touch screen in a full-screen mode before the event occurs.

3. The mobile communication terminal of claim 2, wherein the controller is further configured to display the event-handling view on a full screen of the touch screen, if the first application is not being executed on the touch screen in the full-screen mode before the event occurs.

4. The mobile communication terminal of claim 1, wherein the controller is further configured to determine whether the occurred event is an emergency event or an ordinary event.

5. The mobile communication terminal of claim 4, wherein the controller is further configured to display a notification indication corresponding to the ordinary event, if the occurred event is an ordinary event.

6. The mobile communication terminal of claim 5, wherein the notification indication is displayed in a pop-up form.

7. The mobile communication terminal of claim 4, wherein the controller is further configured to generate an event-handling view corresponding to the emergency event in the second window in a smaller size than the first window, and display the second window overlapped on the first window, if the occurred event is an emergency event.

8. The mobile communication terminal of claim 5, wherein upon externally receiving an event handling command corresponding to the notification indication handled in the pop-up form, the controller is further configured to generate an event-handling view corresponding to the ordinary event and displays the event-handling view in the second window.

9. The mobile communication terminal of claim 1, wherein the controller is further configured to display multiple event-handling views in the second window independently in an overlapping manner if there are multiple event-handling events.

10. The mobile communication terminal of claim 9, wherein the controller is further configured to display the last occurred event-handling view above all other views based on when each of the multiple event-handling views occurred.

11. The mobile communication terminal of claim 1, wherein the controller comprises:
an event dispatcher configured to handle at least one occurred event in units of queues on a First-In-First-Out (FIFO) basis; and
an event handler configured to determine a type of at least one event that is sequentially received from the event dispatcher, read an algorithm for handling events based on the determined type, and render an event-handling view corresponding to the event.

12. The mobile communication terminal of claim 11, wherein the controller further comprises a window display manager configured to render an image to display the first application and the rendered event-handling view in the first and second windows, respectively;
wherein the event handler notifies the occurrence of an event to the first application.

13. A method for controlling a mobile communication terminal with a touch screen displaying a first window for execution of a first application and a second window for execution of a second application, comprising:
displaying, on the touch screen, the first window in which the first application is executed;
determining whether an event requiring display on the touch screen has occurred;
generating, if the event has occurred, an event-handling view corresponding to the event; and
generating the event-handling view in the second window and displaying the second window overlapped on the first window.

14. The method of claim 13, further comprising determining whether the first application is being executed on the touch screen in a full-screen mode before the event occurs.

15. The method of claim 14, further comprising displaying the event-handling view on the touch screen, if the first application is not being executed on the touch screen in a full-screen mode before the event occurs.
